(19) United States
(12) Patent Application Publication
(10) Pub. No.: US 2023/0336655 A1
(43) Pub. Date: Oct. 19, 2023

(54) FOLDABLE ELECTRONIC APPARATUS AND METHOD FOR SUPPLYING ELECTRICAL POWER TO EXTERNAL ELECTRONIC APPARATUS BY USING FOLDABLE ELECTRONIC APPARATUS

(71) Applicant: SAMSUNG ELECTRONICS CO., LTD., Suwon-si (KR)

(72) Inventor: Seyeon LEE, Suwon-si (KR)

(21) Appl. No.: 18/338,349

(22) Filed: Jun. 21, 2023

Related U.S. Application Data
(63) Continuation of application No. PCT/KR2021/020015, filed on Dec. 28, 2021.

(30) Foreign Application Priority Data
Jan. 29, 2021 (KR) 10-2021-0013565

(51) Int. Cl. H04M 1/72454; H04M 1/02; H04B 5/00; H02J 50/10

(52) U.S. Cl. CPC H04M 1/72454; H04M 1/0216; H04B 5/0037; H02J 50/10; H04M 2250/12

(57) ABSTRACT

An electronic apparatus uses a sensor module to check whether the electronic apparatus is in an unfolded state, uses the sensor module to check whether a first surface, which is concealed in a folded state and externally visible in the unfolded state, is lying on an external ground surface, checks, in response to the electronic apparatus being in the unfolded state and the first surface lying on the external ground surface, whether the external electronic apparatus is present on a charging unit, turns on a screen of a sub display, which is facing in the opposite direction as the first surface, in response to the external electronic apparatus being present on the charging unit, uses the charging unit to wirelessly supply electrical power to the external electronic apparatus, and keeps the screen of the sub display on while electrical power is being supplied to the external electronic apparatus.

### CROSS-REFERENCE TO RELATED APPLICATIONS

This application is a continuation application, under 35 U.S.C. § 111(a), of International Patent Application No. PCT/KR2021/020015, filed on Dec. 28, 2021, which claims priority to Korean Patent Application No. 10-2021-0013565, filed on Jan. 29, 2021, the content of which in its entirety is herein incorporated by reference.

### BACKGROUND

### 1. Technical Field

Various embodiments disclosed herein relate to a foldable electronic device and a method of supplying power to an external electronic device using the foldable electronic device.

### 2. Description of the Related Art

An electronic device may include a foldable electronic device capable of changing a display into an unfolded state and a folded state. The foldable electronic device may display a screen through a main display in the unfolded state and display a screen through a sub-display in the folded state.

An electronic device may share power stored in a battery with other electronic devices. The other electronic devices may be portable electronic devices such as smart phones or wearable electronic devices such as smart watches, bands, and Bluetooth™ headsets. The electronic device may wirelessly supply power to another electronic device to charge the another electronic device. Both a non-flexible electronic device and the foldable electronic device may supply power to the other electronic devices.

The foldable electronic device may include a charger disposed on an opposite side to the main display. The foldable electronic device may include a charger disposed in an area other than an area where a sub-display is disposed. The foldable electronic device may supply power to another electronic device based on the another electronic device being placed on the charger.

### SUMMARY

The foldable electronic device may be placed to allow the charger to face upward such that another electronic device is disposed on the charger. When the foldable electronic device is placed to allow the charger to face upward while the foldable electronic device has been folded, the main display may be covered and the sub-display may be placed to face the floor. When the foldable electronic device is placed to allow the charger to face upward while the foldable electronic device has been unfolded, the main display may face the floor and the sub-display may be turned off.

It may not be easy for a user to use the foldable electronic device because the screens of the main display and sub-display cannot be viewed by the user while the foldable electronic device is supplying power to another electronic device. Also, it may not be easy to identify a state of charge while the foldable electronic device supplies power to other electronic devices.

Various embodiments disclosed herein provide a foldable electronic device capable of allowing a user to use the foldable electronic device and identify a state of charge while supplying power to another electronic device and a method of supplying power to an external electronic device using the foldable electronic device.

In an embodiment disclosed herein, an electronic device including a folded state and an unfolded state includes a housing including a first side that is covered in the folded state and visible to outside in the unfolded state, and a second side that faces a direction opposite to the first side in the unfolded state, a main display externally visible to the outside through the first side in the unfolded state, a sub-display disposed in a first area of the second side, a charger disposed in a second area of the second side, a sensor module and a processor operatively connected to the main display, the sub-display, the charger, and the sensor module, wherein the processor may determine whether the electronic device is in the unfolded state using the sensor module, determine whether the first side is placed on an external ground using the sensor module, determine whether an external electronic device exists in the charger in response to the electronic device being in the unfolded state and the first side being placed on the external ground, turn on a screen of the sub-display in response to existence of the external electronic device in the charger, wirelessly supply power to the external electronic device using the charger, and maintain the screen of the sub-display turned on while supplying the power to the external electronic device.

In an embodiment disclosed herein, a method of supplying power to an external electronic device using an electronic device may include determining whether the electronic device is in an unfolded state by a sensor module of the electronic device, determining whether a first side of a housing of the electronic device is placed on an external ground by the sensor module, determining whether an external electronic device exists in a charger of the electronic device in response to the electronic device being in the unfolded state and the first side being placed on the external ground, turning on a screen of a sub-display of the electronic device in response to existence of the external electronic device in the charger, supplying power wirelessly to the external electronic device using the charger, and maintaining the screen of the sub-display turned on while supplying the power to the external electronic device.

By the embodiments disclosed herein, a user may use a foldable electronic device through a sub-display while power is supplied to another electronic device.

Also, in the embodiments disclosed herein, a state of charge may be identified while a foldable electronic device supplies power to another electronic device.

In addition, various effects identified directly or indirectly through the disclosure may be provided.

### BRIEF DESCRIPTION OF DRAWINGS

The above and other exemplary embodiments, advantages and features of this disclosure will become more apparent by describing in further detail exemplary embodiments thereof with reference to the accompanying drawings, in which:

FIG. 1 is a block diagram of an embodiment of an electronic device in a network environment.

FIG. 2 is a block diagram of an embodiment of a display device.

FIG. 3 is a diagram showing an embodiment of an unfolded state of an electronic device.

FIG. 4 is a diagram illustrating an embodiment of a folded state of an electronic device.

FIG. 5 is an exploded perspective view of an embodiment of an electronic device.

FIG. 6 is a diagram showing an embodiment of a charger for an electronic device.

FIG. 7 is a diagram illustrating an embodiment in which an external electronic device exists in a charger of an electronic device.

FIG. 8 is a diagram illustrating an embodiment in which an electronic device supplies power to an external electronic device.

FIG. 9 is a flowchart illustrating an embodiment of a method of supplying power to an external electronic device using an electronic device.

FIG. 10 is a flowchart illustrating an embodiment of a method of charging an external electronic device using an electronic device.

FIG. 11 is a flowchart illustrating an embodiment of a method of performing wireless power sharing while controlling a sub-display based on a state of an electronic device and whether or not the electronic device is connected to a charging device.

With regard to description of drawings, the same or similar components will be marked by the same or similar reference signs.

### DETAILED DESCRIPTION

Hereinafter, various embodiments of the disclosure are described with reference to the accompanying drawings. However, it is not intended to limit the disclosure to illustrative embodiments, and it should be understood that various modifications, equivalents, and/or alternatives of embodiments of the disclosure are included.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

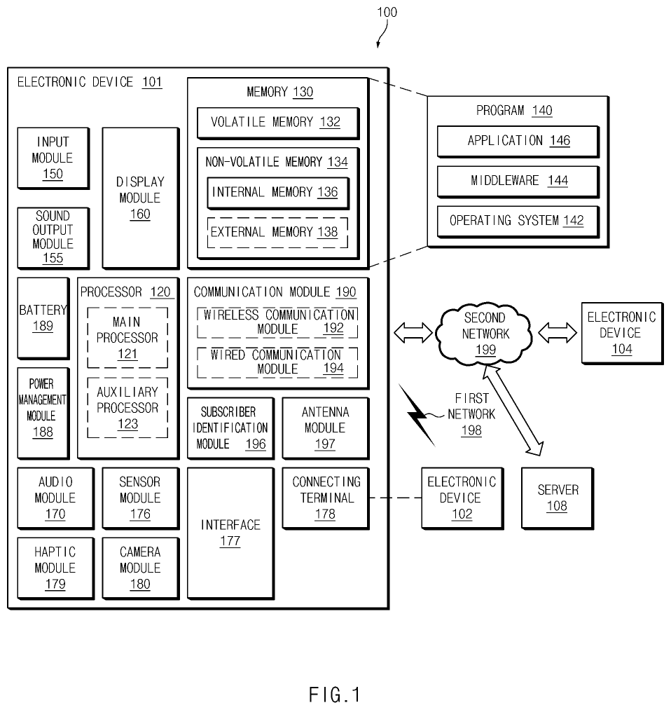

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display module 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display module 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display module 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the NPU) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent DNN (BRDNN), deep Q-network or a combination of two or more thereof but is not limited thereto. The artificial intelligence model may, additionally or alternatively, include a software structure other than the hardware structure.

component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The driving unit 181 may move the display module 160 into and/or out of the electronic device 101. The driving unit 181 may control the display module 160 to be converted into a normal mode disposed inside the electronic device 101 and an expanded mode extended to the outside of the electronic device 101. there is. The driving unit 181 may be a slide-type rail structure and/or a motor disposed inside the electronic device 101, but is not limited thereto.

The rotating unit 183 moves the display module 160 into and/or out of the electronic device 101, or when the display module 160 moves into and/or out of the electronic device 101, the rotating unit 183 may serve as a support for supporting the 160. The rotating unit 183 may be inserted into the rollable display module 160 while being rolled or extended to the outside of the electronic device 101 while the display module 160 is unfolded. The rotating unit 183 may be a cylinder-shaped rotating body disposed on a side surface of the electronic device 101.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or IR data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or MEC. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

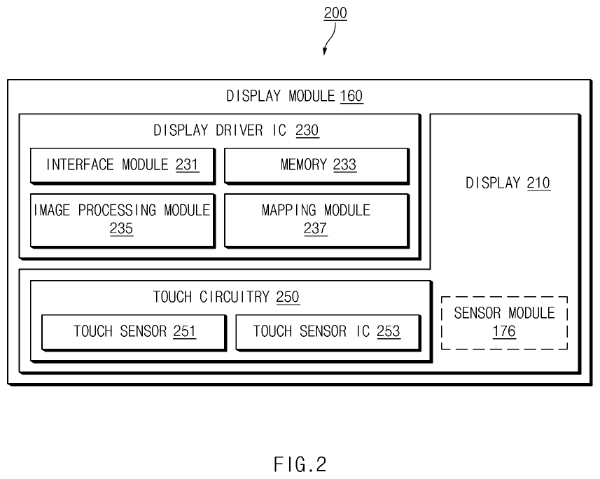

FIG. 2 is a block diagram 200 illustrating the display module 160 according to various embodiments. Referring to FIG. 2, the display module 160 may include a display 210 and a display driver integrated circuit (DDI) 230 to control the display 210. The DDI 230 may include an interface module 231, memory 233 (e.g., buffer memory), an image processing module 235, or a mapping module 237. The DDI 230 may receive image information that contains image data or an image control signal corresponding to a command to control the image data from another component of the electronic device 101 via the interface module 231. For example, according to an embodiment, the image information may be received from the processor 120 (e.g., the main processor 121 (e.g., an AP)) or the auxiliary processor 123 (e.g., a graphics processing unit) operated independently from the function of the main processor 121. The DDI 230 may communicate, for example, with touch circuitry 150 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210. The mapping module 237 may generate a voltage value or a current value corresponding to the image data pre-processed or post-processed by the image processing module 235. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 210 may be driven, for example, based at least in part on the voltage value or the current value such that visual information (e.g., a text, an image, or an icon) corresponding to the image data may be displayed via the display 210.

According to an embodiment, the display module 160 may further include the touch circuitry 250. The touch circuitry 250 may include a touch sensor 251 and a touch sensor IC 253 to control the touch sensor 251. The touch sensor IC 253 may control the touch sensor 251 to sense a touch input or a hovering input with respect to a certain position on the display 210. To achieve this, for example, the touch sensor 251 may detect (e.g., measure) a change in a signal (e.g., a voltage, a quantity of light, a resistance, or a quantity of one or more electric charges) corresponding to the certain position on the display 210. The touch circuitry 250 may provide input information (e.g., a position, an area, a pressure, or a time) indicative of the touch input or the hovering input detected via the touch sensor 251 to the processor 120. According to an embodiment, at least part (e.g., the touch sensor IC 253) of the touch circuitry 250 may be formed as part of the display 210 or the DDI 230, or as part of another component (e.g., the auxiliary processor 123) disposed outside the display module 160.

According to an embodiment, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 150)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display module 160 includes a pressure sensor, the pressure sensor may obtain pressure information corresponding to a touch input received via a partial or whole area of the display 210. According to an embodiment, the touch sensor 251 or the sensor module 176 may be disposed between pixels in a pixel layer of the display 210, or over or under the pixel layer.

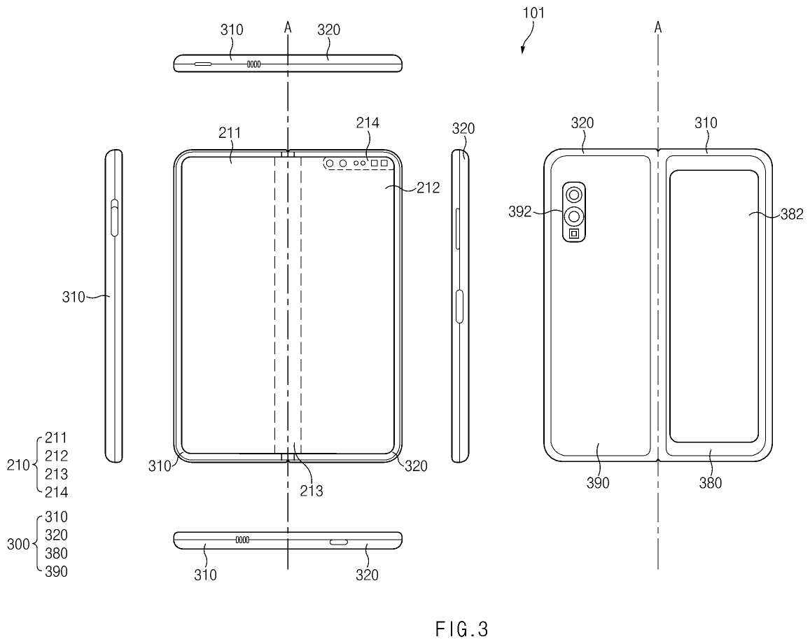

FIG. 3 is a diagram showing an embodiment of an unfolded state of the electronic device 101. The electronic device 101 in an embodiment may be the foldable electronic device 101 capable of changing the electronic device 101 and a display (e.g., display panel) 210 into a folded state or an unfolded state.

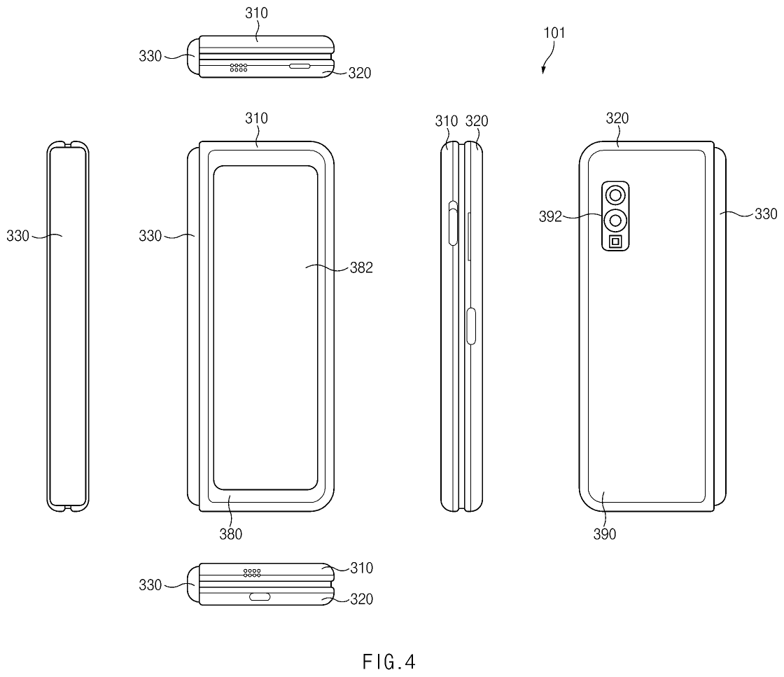

In an embodiment, the electronic device 101 may include a housing 300, a hinge cover 330 (refer to FIG. 4) covering a folded portion of the housing 300, and the display 210 disposed in a space defined by the housing 300. In the specification, a side on which the display 210 is disposed is defined as a first side or a front side of the electronic device 101. Further, in the specification, the opposite side of the front side is defined as a second side or a rear side of the electronic device 101. In addition, a side surrounding a space between the front side and the rear side is defined as a third side or a lateral side of the electronic device 101.

In an embodiment, the housing 300 may include a first front housing 310, a second front housing 320, a first rear cover 380, and a second rear cover 390. The housing 300 may not be limited to the forms and couplings shown in FIGS. 3 and 4. The housing 300 may be implemented by a combination and/or coupling of different shapes or parts. In an embodiment, in another embodiment, the first front housing 310 and the first rear cover 380 may be unitary, for example. Also, in another embodiment, the second front housing 320 and the second rear cover 390 may be unitary.

In an embodiment, the first front housing 310 and the second front housing 320 may be disposed on opposite sides of a folding axis (A-axis), which is a boundary line along which the electronic device 101 and the display 210 are folded. The first front housing 310 and the second front housing 320 may have generally symmetrical shapes with respect to the folding axis (A-axis). The angle or distance between the first front housing 310 and the second front housing 320 may vary depending on whether the electronic device 101 and the display 210 are in an unfolded state, a folded state, or an intermediate state between the unfolded state and the folded state.

In an embodiment, the first front housing 310 and the second front housing 320 may define a recess accommodating the display 210 together. At least a portion of the first front housing 310 and the second front housing 320 may include or consist of a metal material or a non-metal material having rigidity equal to or higher than a predetermined threshold value to support the display 210.

In an embodiment, the display 210 may be disposed in a space defined by the housing 300. In an embodiment, the display 210 may be seated on a recess defined by the housing 300, for example. The display 210 may constitute most of the front side of the electronic device 101.

In an embodiment, at least a portion of the display 210 may be deformed into a flat or curved surface. The display 210 may include a folding area 213 that is a folded or unfolded area, a first portion 211 disposed on one side of the folding area 213 (e.g., the left side of the folding area 213 shown in FIG. 3), and a second portion 212 disposed on the other side of the folding area 213 (the right side of the folding area 213 shown in FIG. 3). The division of the area of the display 210 shown in FIG. 3 is an illustrative embodiment, and the display 210 may be divided into a plurality of areas according to structures or functions. In an embodiment, the area of the display 210 may be divided with respect to the folding area 213 mainly extending in the vertical direction of the display 210 or the folding axis (A-axis), like the display 210 shown in FIG. 3, for example. In another embodiment, the display 210 may be divided with respect to a folding area mainly extending in the horizontal direction of the display 210 or another folding axis. The first portion 211 and the second portion 212 may have generally symmetrical shapes around the folding area 213. However, when a sensor area 214 is included in the display 210, the first portion 211 and the second portion 212 may have asymmetrical shapes.

In an embodiment, the display 210 may further include the sensor area 214. The sensor area 214 may occupy a predetermined area within the second portion 212 of the display 210. However, the sensor area 214 is not limited thereto, and the sensor area 214 may be defined within the first portion 211 or defined in the first portion 211 and the second portion 212 in a divided manner.

In an embodiment, the sensor area 214 may be adjacent to one side edge of the first front housing 310 and/or the second front housing 320. In an embodiment, the sensor area 214 may be adjacent to an upper corner of the second front housing 320, for example. The arrangement, shape, and size of the sensor area 214 are not limited to the illustrated example. In an embodiment, the sensor area 214 may be defined in a lower corner of the second front housing 320 or an arbitrary area between the upper and lower corners, for example. The sensor area 214 may be disposed at a lower portion of the first portion 211 and/or the second portion 212 of the display 210. The display 210 of FIG. 3 may be an Infinity-O Display in which the sensor area 214 including a front camera is integrally implemented with the first portion 211 and/or the second portion 212 of the display 210 because the entirety of the portion of the display 210 except for the front camera and a sensor hole is implemented as a display area.

In an embodiment, the pixel structure of the first portion 211 and/or the second portion 212 disposed in the upper end of the sensor area 214 may be different from the pixel structure of the remaining first portion 211 and/or second portion 212. In an embodiment, the first portion 211 and/or the second portion 212 disposed in the upper end of the sensor area 214 may have a lower pixel density than that of the remaining first portion 211 and/or second portion 212, for example. In another embodiment, the pixels disposed in the first portion 211 and/or the second portion 212 disposed in the upper end of the sensor area 214 may have a smaller size than pixels disposed in the remaining first portion 211 and/or second portion 212. In another embodiment, the form and/or shape of the pixels arranged in the first portion 211 and/or second portion 212 disposed in the upper end of the sensor area 214 may be narrower or longer compared to the pixels arranged in the remaining first portion 211 and/or second portion 212.

In an embodiment, components for performing various functions embedded in the electronic device 101 may be visually exposed on the front side of the electronic device 101 through the sensor area 214 or one or more openings provided in the sensor area 214. In various embodiments, components may include various types of sensors (e.g., the sensor module 176 of FIG. 1). The sensor may include at least one of a front camera, a receiver, or a proximity sensor, for example.

In an embodiment, the first rear cover 380 may be disposed on the rear side of the electronic device 101. The first rear cover 380 may be disposed on one side with respect to the folding axis (A-axis). The first rear cover 380 may have a substantially quadrangular periphery, e.g., rectangular periphery. The periphery of the first rear cover 380 may be covered by the first front housing 310.

In an embodiment, the second rear cover 390 may be disposed on the rear side of the electronic device 101. The second rear cover 390 may be disposed on the opposite side of the first rear cover 380 with respect to the folding axis (A-axis). The second rear cover 390 may have substantially quadrangular periphery, e.g., rectangular periphery. The periphery edge of the second rear cover 390 may be covered by the second front housing 320.

In an embodiment, the first rear cover 380 and the second rear cover 390 may have substantially symmetrical shapes around the folding axis (A-axis). However, the first rear cover 380 and the second rear cover 390 do not necessarily have symmetrical shapes, and in another embodiment, the electronic device 101 may include various shapes of the first rear cover 380 and various shapes of the second rear cover 390. In another embodiment, the first rear cover 380 may be unitary with the first front housing 310, and the second rear cover 390 may be unitary with the second front housing 320.

In an embodiment, the front side of the electronic device 101 may include the display 210, a partial area of the first front housing 310 adjacent to the display 210, and a partial area of the second front housing 320. The rear side of the electronic device 101 may include the first rear cover 380, a partial area of the first front housing 310 adjacent to the first rear cover 380, the second rear cover 390, and a partial area of the second front housing 320 adjacent to the second rear cover 390.

In an embodiment, the first front housing 310, the second front housing 320, the first rear cover 380, and the second rear cover 390 may define a space capable of accommodating various components (e.g., a printed circuit board (PCB) or a battery).

In an embodiment, one or more components may be disposed or visually exposed on the rear side of the electronic device 101. In an embodiment, at least a portion of a sub-display 382 may be visually exposed through the first rear cover 380, for example. In another embodiment, at least a portion of a rear sensor module 392 (e.g., the sensor module 176 of FIG. 1) may be visually exposed through the second rear cover 390. The rear sensor module 392 may include a proximity sensor and/or a rear camera.

In an embodiment, when the electronic device 101 is in an unfolded state, the first front housing 310 and the second front housing 320 may be arranged to face the same direction while defining an angle of about 180 degrees. When the display 210 is in the unfolded state, the surface of the first portion 211 and the surface of the second portion 212 of the display 210 may define an angle of about 180 degrees to each other. When the display 210 is in the unfolded state, the first portion 211 and the second portion 212 of the display 210 may face the same direction (e.g., the front direction of the electronic device 101). When the display 210 is in an unfolded state, the folding area 213 may define the same plane as that of the first portion 211 and the second portion 212.

FIG. 4 is a diagram showing an embodiment of a folded state of the electronic device 101.

In an embodiment, the hinge cover 330 may be disposed between the first front housing 310 and the second front housing 320. The hinge cover 330 may cover a portion between the first front housing 310 and the second front housing 320. The hinge cover 330 may cover a hinge structure between the first front housing 310 and the second front housing 320. The hinge cover 330 may be covered by parts of the first front housing 310 and the second front housing 320 when the electronic device 101 is in an unfolded state. The hinge cover 330 may be exposed to the outside when the electronic device 101 is in a folded state. The hinge cover 330 may include a curved surface.

In an embodiment, when the electronic device 101 is in the folded state, the first front housing 310 and the second front housing 320 may face each other. When the display 210 is in the folded state, the surface of the first portion 211 and the surface of the second portion 212 of the display 210 may define a narrow angle (e.g., between 0 degrees and about 10 degrees). When the display 210 is in the folded state, the first portion 211 and the second portion 212 of the display 210 may face each other. When the display 210 is in a folded state, at least a portion of the folding area 213 may change to a curved surface having a first curvature.

In an embodiment, when the electronic device 101 is in the intermediate state between the unfolded state and the folded state, the first front housing 310 and the second front housing 320 may be disposed at an angle falling within a range of 0 degrees to less than 180 degrees. When the display 210 is in the intermediate state, the surface of the first portion 211 and the surface of the second portion 212 of the display 210 may define an angle greater than that of the folded state and smaller than that of the unfolded state. When the display 210 is in the intermediate state, at least a portion of the folding area 213 may change to a curved surface having a second curvature. The second curvature may be smaller than the first curvature.

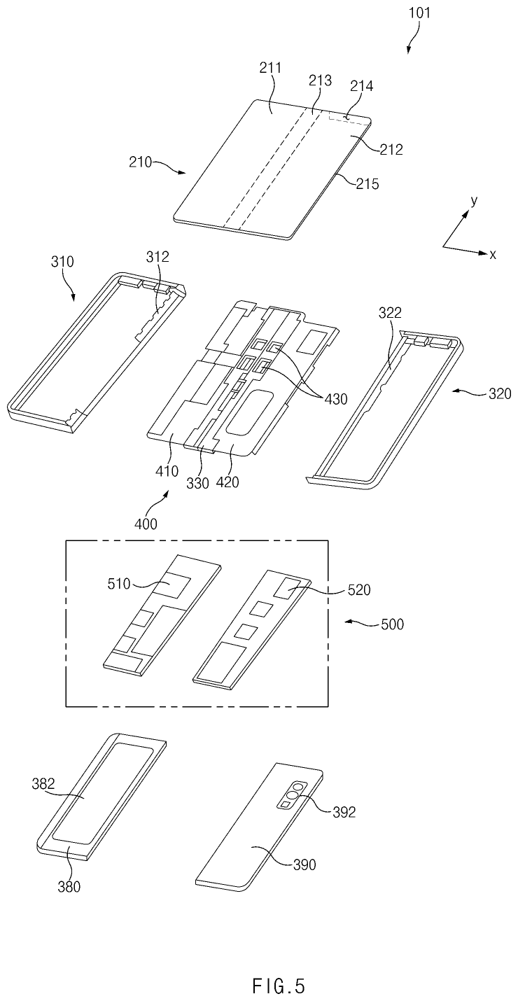

FIG. 5 is an exploded perspective view of an embodiment of the electronic device 101. The electronic device 101 in an embodiment may include the display 210, a bracket assembly 400, a board portion 500, the first front housing 310, the second front housing 320, the first rear cover 380 and the second rear cover 390.

In an embodiment, the display 210 may include the first portion 211, the second portion 212, the folding area 213, the sensor area 214, and a layer structure 215.

In an embodiment, the layer structure 215 may seat display 210 in a recess of the housing 300. The layer structure 215 may be comprised of one or more plates. The layer structure 215 may be disposed on the bracket assembly 400.

In an embodiment, the bracket assembly 400 may be disposed between the layer structure 215 and the board portion 500. The bracket assembly 400 may include a first bracket 410, a second bracket 420, the hinge cover 330 disposed between the first bracket 410 and the second bracket 420, and a wiring member 430 crossing the first bracket 410 and the second bracket 420.

In an embodiment, the first bracket 410 may be disposed between the first portion 211 of the display 210 and a first board 510 of the board portion 500. The second bracket 420 may be disposed between the second portion 212 of the display 210 and a second board 520 of the board portion 500.

In an embodiment, the wiring member 430 may be disposed in a direction (e.g., an x-axis direction) crossing the first bracket 410 and the second bracket 420. The wiring member 430 may be disposed in a direction (e.g., the x-axis direction) perpendicular to the folding axis (e.g., a y-axis or the folding axis (A-axis) of FIG. 3) of the folding area 213 of the electronic device 101. The wiring member 430 may be a flexible printed circuit board (FPCB).

In an embodiment, the board portion 500 may include the first board 510 disposed on the side of the first bracket 410 and the second board 520 disposed on the side of the second bracket 420. The first board 510 and the second board 520 may be disposed inside a space defined by the bracket assembly 400, the first front housing 310, the second front housing 320, the first rear cover 380, and the second rear cover 390. Components for realizing various functions of the electronic device 101 may be disposed on the first board 510 and the second board 520.

In an embodiment, the first front housing 310 and the second front housing 320 may be assembled to each other to be coupled to opposite sides of the bracket assembly 400 in a state where the display 210 is coupled to the bracket assembly 400. The first front housing 310 and the second front housing 320 may be coupled to the bracket assembly 400 by sliding on opposite sides of the bracket assembly 400.

In an embodiment, the first front housing 310 may include a first rotation support surface 312. The second front housing 320 may include a second rotation support surface 322 corresponding to the first rotation support surface 312. The first rotation support surface 312 and the second rotation support surface 322 may include a curved surface corresponding to the curved surface included in the hinge cover 330.

In an embodiment, the first rotation support surface 312 and the second rotation support surface 322 may cover the hinge cover 330 when the electronic device 101 is the unfolded state (e.g., the electronic device 101 of FIG. 3). Accordingly, when the electronic device 101 is in the unfolded state, the hinge cover 330 may not be exposed or minimally exposed to the rear side of the electronic device 101.

In an embodiment, the first rotation support surface 312 and the second rotation support surface 322 may rotate along the curved surface included in the hinge cover 330 when the electronic device 101 is in the folded state (e.g., the electronic device 101 of FIG. 4). Accordingly, when the electronic device 101 is in the folded state, the hinge cover 330 may be maximally exposed to the rear side of the electronic device 101.

An electronic device in an embodiment (e.g., the electronic device 101 of FIGS. 1 and 3 to 5) may include a folded state and an unfolded state. The electronic device 101 may be a foldable electronic device. The electronic device 101 may include a housing (e.g., the housing 300 of FIG. 3) including a first side (front side) that is covered in the folded state and visible to the outside in the unfolded state and a second side (rear side) facing in an opposite direction to the first side in the unfolded state. The electronic device 101 may include a main display (e.g., the display 210 of FIGS. 2 to 5) that is externally visible through the first side in the unfolded state. The electronic device 101 may include a sub-display (e.g., the sub-display 382 of FIGS. 3 to 5) disposed in a first area (e.g., the first rear cover 380 of FIGS. 3 to 5) of the second side. The electronic device 101 may include a sensor module (e.g., the sensor module 176 of FIG. 1). The electronic device 101 may include the main display 210, the sub-display 382, and a processor operatively connected to the sensor module 176 (e.g., the processor 120 of FIG. 1).

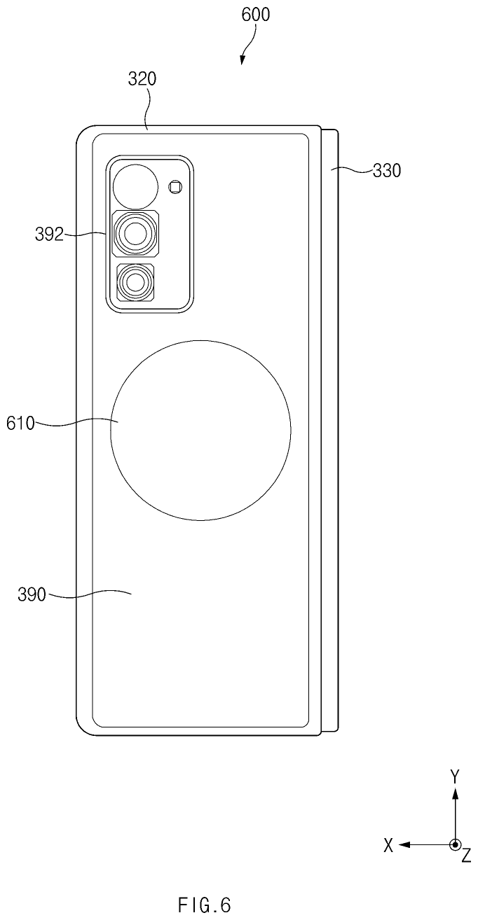

FIG. 6 is a diagram 600 illustrating an embodiment of a charger 610 for an electronic device (e.g., the electronic device 101 of FIGS. 1 and 3 to 5).

In an embodiment, the electronic device 101 may be in a folded state. The electronic device 101 may be disposed such that the second front housing 320 of a housing (e.g., the housing 300 of FIG. 3) faces a first direction (−Z-axis direction). When the second front housing 320 faces in the first direction (−Z-axis direction), the second rear cover 390 of the housing 300 may face a second direction (+Z-axis direction) opposite to the first direction (−Z-axis direction). The rear sensor module 392 disposed in the second rear cover 390 may face the second direction (+Z-axis direction).

In an embodiment, the charger 610 may be disposed in a second area of the second side (rear side) of the housing 300. The second area may be a different area from the first area where the sub-display (e.g., the sub-display 382 of FIGS. 3 to 5) is disposed. The charger 610 may be disposed in the second rear cover 390 different from the first rear cover 380 where the sub-display 382 is disposed. The charger 610 may face the second direction (+Z-axis direction).

In an embodiment, the first area may be an area where the first rear cover (e.g., the first rear cover 380 of FIGS. 3 to 5) of the second side of the housing 300 is disposed. The second area may be an area where the second rear cover 390 of the second side of the housing 300 is disposed. The first area and the second area may be arranged on opposite sides of each other with respect to a folding axis (e.g., the folding axis (A-axis) in FIG. 3), which is a boundary line along which the main display (e.g., the display 210 of FIGS. 2 to 5) is folded.

In an embodiment, the charger 610 may receive power from a battery (e.g., the battery 189 of FIG. 1). The charger 610 may wirelessly emit power in the second direction (+Z-axis direction). A distance at which the charger 610 emits power may be a short distance of about 10 centimeter (cm) or less.

In an embodiment, the charger 610 may include a charging coil. The charging coil may generate induced power by electromagnetic induction. The charging coil may wirelessly emit the induced power.

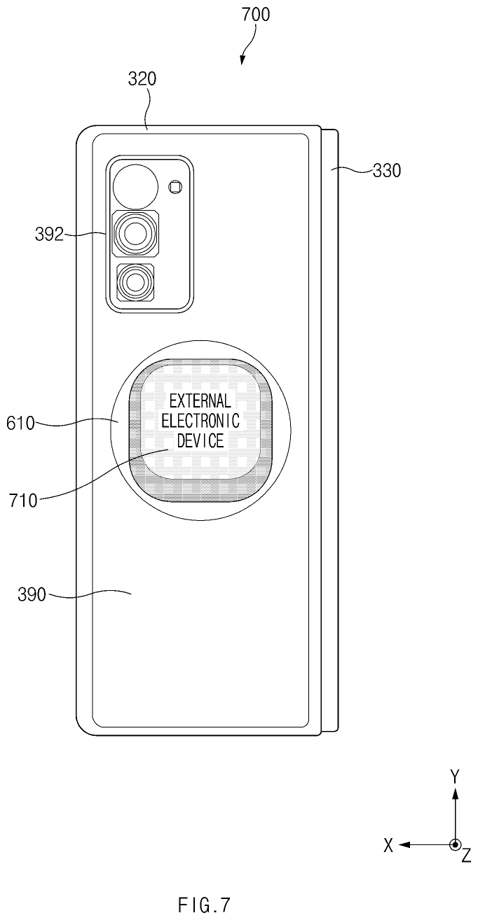

FIG. 7 is a diagram 700 illustrating that an external electronic device 710 exists in the charger 610 of an electronic device (e.g., the electronic device 101 of FIGS. 1 and 3 to 5).

In an embodiment, the external electronic device 710 may exist in the charger 610 when the electronic device 101 is in the folded state. The external electronic device 710 may be placed on the charger 610. The external electronic device 710 may be placed adjacent to the charger 610 in the second direction (+Z-axis direction). The external electronic device 710 may be a different electronic device from the electronic device 101. In an embodiment, the external electronic device 710 may be another portable electronic device such as a smart phone, for example. In another embodiment, the external electronic device 710 may be a wearable electronic device such as a smart watch, a band, and a Bluetooth™ headset.

In an embodiment, the electronic device 101 may wirelessly transmit power to the external electronic device 710. A processor of the electronic device 101 (e.g., the processor 120 of FIG. 1) may wirelessly transmit power to the external electronic device 710 using the charger 610. The electronic device 101 may charge the external electronic device 710. The electronic device 101 may share power wirelessly with the external electronic device 710.

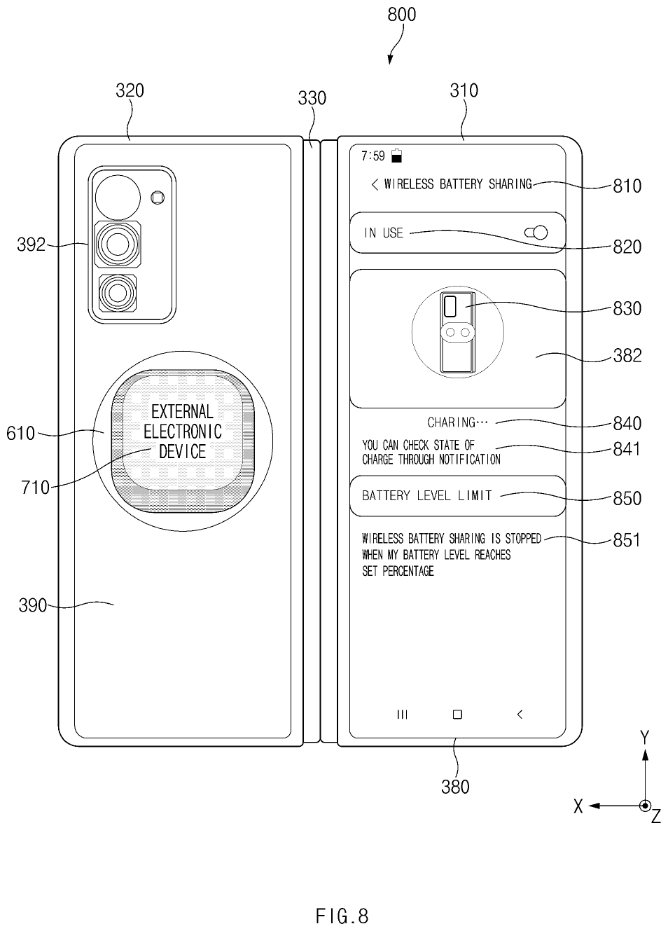

FIG. 8 is a diagram 800 illustrating that an electronic device (e.g., the electronic device 101 of FIGS. 1 and 3 to 5) in an embodiment supplies power to the external electronic device 710.

In an embodiment, the first side (front side) of the electronic device 101 may be placed on an external ground in the unfolded state. The external ground may be a reference plane supporting the electronic device 101 from below. In an embodiment, the external ground may be a floor, for example. In another embodiment, the external ground may be a desk or table top. When the external ground is a surface supporting the electronic device 101 in the first direction (−Z-axis direction), the first side (front side) of the electronic device 101 may be placed on the external ground. The electronic device 101 may be disposed such that the first front housing 310 and the second front housing 320 of the housing (e.g., the housing 300 of FIG. 3) face the first direction (−Z-axis direction).

In an embodiment, the processor (e.g., the processor 120 of FIG. 1) may determine whether the electronic device 101 is in the unfolded state or the folded state by a sensor module (e.g., the sensor module 176 of FIG. 1). In an embodiment, the sensor module 176 may include a Hall sensor, for example. The processor 120 may determine whether the electronic device 101 is in the unfolded state or the folded state by a hall sensor.

In an embodiment, the processor 120 may determine whether the first side (front side) of the electronic device 101 is placed on an external ground by the sensor module 176. In an embodiment, the sensor module 176 may include at least one of an acceleration sensor, a gyro sensor, a proximity sensor, an illuminance sensor, and a geomagnetic sensor, for example. The processor 120 may determine whether the first side (front side) of the electronic device 101 is placed on an external ground by at least one of an acceleration sensor, a gyro sensor, a proximity sensor, an illuminance sensor, and a geomagnetic sensor. In an embodiment, the processor 120 may determine whether the first side (front side) of the electronic device 101 faces the external ground by an acceleration sensor, for example. In another embodiment, the processor 120 may determine whether the first side (front side) of the electronic device 101 faces the floor by a gyro sensor. As still another example, the processor 120 may determine whether the first side (front side) of the electronic device 101 is adjacent to an external object by a proximity sensor. As still another example, the processor 120 may determine whether an external environment facing the first side (front side) of the electronic device 101 is darkened by the external ground by an illuminance sensor. As still another example, the processor 120 may determine whether a direction in which the electronic device 101 is placed is a direction in which the first side (front side) faces downward by a geomagnetic sensor. However, the disclosure is not limited thereto, and the electronic device 101 may determine whether the first side (front side) of the electronic device 101 is placed on the external ground by at least one sensor included in the sensor module 176.

In an embodiment, when the first front housing 310 and the second front housing 320 face in the first direction (−Z-axis direction), the main display (e.g., the display 210 of FIGS. 2 to 5) may face the first direction (−Z-axis direction). When the first direction (−Z-axis direction) is downward or toward the external ground, the main display 210 may not be visible to a user. In an embodiment, when the electronic device 101 is placed on the floor in the unfolded state, the main display 210 may not be visible to the user, for example.

In an embodiment, when the first side (front side) of the electronic device 101 is placed on an external ground in the unfolded state, the first front housing 310 and the second front housing 320 of the housing 300 may face the first direction (−Z-axis direction). When the first front housing 310 and the second front housing 320 of the housing 300 face the first direction (−Z-axis direction), the first rear cover 380 and the second rear cover 390 of the housing 300 may face a second direction (+Z-axis direction) opposite to the first direction (−Z-axis direction). The sub-display 382 disposed on the first rear cover 380 and the charger 610 disposed on the second rear cover 390 may face the second direction (+Z-axis direction).

In an embodiment, the external electronic device 710 may exist in the charger 610. The external electronic device 710 may be placed in the second direction (+Z-axis direction) on the charger 610.

In an embodiment, the processor 120 may determine whether the external electronic device 710 exists in the charger 610 in response to the electronic device 101 being in the unfolded state and the first side (front side) being placed on an external ground. The processor 120 may periodically determine whether the external electronic device 710 exists. In an embodiment, the user may preset a cycle at which the processor 120 determines whether the external electronic device 710 exists, for example. In another embodiment, a cycle at which the processor 120 determines whether the external electronic device 710 exists may be set according to the remaining capacity of the battery (e.g., the battery 189 of FIG. 1).

In an embodiment, the processor 120 may turn on the screen of the sub-display 382 in response to the existence of the external electronic device 710 on the charger 610. The processor 120 may turn on the screen of the sub-display 382 based on detection that the external electronic device 710 is placed on the charger 610. When the external electronic device 710 is placed on the charger 610, the processor 120 may determine that the electronic device 101 is placed in a state in which the user cannot view the main display (e.g., the display 210 of FIGS. 2 to 5), and turn on the screen of the sub-display 382. The processor 120 may turn on the screen of the sub-display 382 such that the user is able to use the screen of the sub-display 382 even when the external electronic device 710 is placed on the charger 610.

In an embodiment, the processor 120 may wirelessly supply power to the external electronic device 710 using the charger 610. The processor 120 may maintain the screen of the sub-display 382 turned on while supplying power to the external electronic device 710. The sub-display 382 may display a charge state of the external electronic device 710. In an embodiment, the sub-display 382 may display at least one of a wireless battery sharing interface 810, an in-use notification interface 820, an interface 830 for notifying a type of the external electronic device 710 placed on the charger 610, a charging notification interface 840, a charging notification guide message 841, a battery level interface 850, and a message 851 notifying wireless battery sharing stop according to a battery level, for example. However, the disclosure is not limited thereto, and the sub-display 382 may display whether the external electronic device 710 is being normally charged. The sub-display 382 may display how much capacity of the battery 189 of the electronic device 101 remains. In another embodiment, when the processor 120 receives data related to the charging level of the external electronic device 710 using a communication circuit (e.g., the wireless communication module (also referred to as a wireless communication circuit) 192 of FIG. 1), the sub-display 382 may display the charging level of the external electronic device 710.

In an embodiment, the sub-display 382 may display an execution screen of a function and/or an application executed by the electronic device 101. In an embodiment, the sub-display 382 may display a home screen, for example. In another embodiment, the sub-display 382 may display the screen of a list of messages received by a message application. The user may use a function of the electronic device 101 or execute an application while the external electronic device 710 is placed on the charger 610, for example.

In an embodiment, the processor 120 may display a screen through the main display 210 when the electronic device 101 is in the unfolded state in responds to the charger 610 detecting the external electronic device 710 in a state where the first side (front side) is in the space. The processor 120 may block display of the screen through the sub-display 382 when the electronic device 101 is in the unfolded state in responds to the charger 610 detecting the external electronic device 710 in a state where the first side (front side) is in space. In an embodiment, the processor 120 may determine that the external electronic device 710 is brought close to the second side (rear side) of the electronic device 101 for a purpose other than charging when the first side (front side) is in space, for example, for example. In another embodiment, the processor 120 may determine that the external electronic device 710 is brought close to the charger 610 of the second side (rear side) while the user uses the electronic device 101 through the main display 210 when the first side (front side) is in space.

In an embodiment, a memory (e.g., the memory 130 of FIG. 1) of the electronic device 101 may store at least one registered near field communication identifier (NFC ID). The memory 130 may register at least one or more NFC IDs of other electronic devices.

In an embodiment, the communication circuit 192 of the electronic device 101 may perform NFC with nearby electronic devices. The communication circuit 192 of the electronic device 101 may identify NFC IDs of nearby electronic devices.

In an embodiment, the processor 120 may identify the NFC ID of the external electronic device 710 using the communication circuit 192 in response to the existence of the external electronic device 710 in the charger 610. The processor 120 may compare the NFC ID of the external electronic device 710 with at least one registered NFC ID stored in the memory 130. The type and model of the external electronic device 710 placed on the charger 610 may be identified.

In an embodiment, the processor 120 may supply power to the external electronic device 710 using the charger 610 in response to the NFC ID of the external electronic device 710 matching at least one registered NFC ID stored in the memory 130. The processor 120 may automatically start charging the external electronic device 710 when the external electronic device 710 placed on the charger 610 has a registered NFC ID.

In an embodiment, the processor 120 may display a user interface for checking whether or not to supply power to the external electronic device 710 on the screen of the sub-display 382 in response to the NFC ID of the external electronic device 710 being different from at least one registered NFC ID stored in the memory 130 or a time desired for the communication circuit 192 to establish NFC with the external electronic device 710 having passed a threshold time. In an embodiment, when the external electronic device 710 placed on the charger 610 has an unregistered NFC ID, the processor 120 may display a user interface for checking whether to start charging the external electronic device 710 on the screen of the sub-display 382, for example. In another embodiment, when the external electronic device 710 placed on the charger 610 is unable to perform NFC with the communication circuit 192, the processor 120 may display a user interface for checking whether to start charging the external electronic device 710 on the screen of the sub-display 382.

In an embodiment, the processor 120 may supply power to the external electronic device 710 using the charger 610 in response to selecting wireless power sharing to supply power to the external electronic device 710 through the user interface for checking whether to start charging the external electronic device 710. The processor 120 may start charging the external electronic device 710 in response to selecting a menu for supplying power to the external electronic device 710 through the user interface.

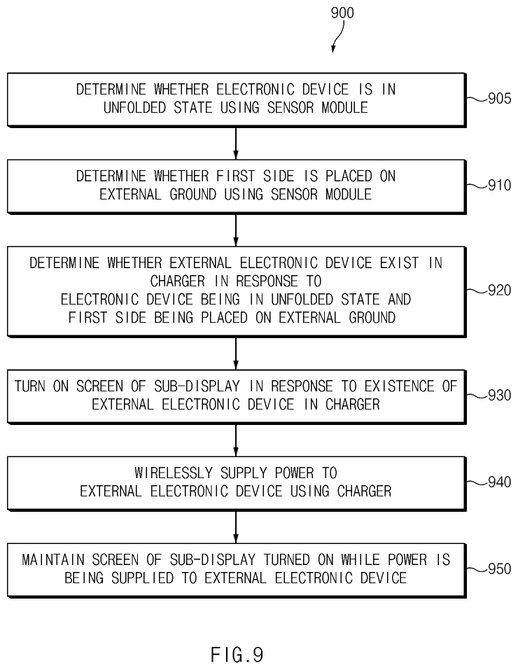

FIG. 9 is a flowchart 900 showing a method of supplying power to an external electronic device (e.g., the external electronic device 710 of FIGS. 7 and 8) using an electronic device (e.g., the electronic device 101 of FIGS. 1 and 3 to 5).

In operation 905, the processor (e.g., processor 120 of FIG. 1) of the electronic device 101 in an embodiment may determine whether the electronic device 101 is in the unfolded state by a sensor module (e.g., the sensor module 176 of FIG. 1) of the electronic device 101. In an embodiment, the processor 120 may determine whether the electronic device 101 is in the unfolded state by a hall sensor, for example.

In operation 910, the processor 120 in an embodiment may determine whether the first side (front side) of the housing of the electronic device 101 (e.g., the housing 300 of FIG. 3) is placed on an external ground using the sensor module 176. In an embodiment, the processor 120 may determine whether the first side (front side) is placed on the floor using at least one of an acceleration sensor, a gyro sensor, a proximity sensor, an illuminance sensor, and a geomagnetic sensor included in the sensor module 176, for example.

In operation 920, the processor 120 in an embodiment may determine whether the external electronic device 710 exists in a charger (e.g., the charger 610 of FIGS. 6 to 8) of the electronic device 101 in response to the electronic device 101 being in the unfolded state and the first side (front side) being placed on an external ground. The processor 120 may determine whether the external electronic device 710 exists in the charger 610 at every specified cycle.

In operation 930, the processor 120 in an embodiment may turn on the screen of the sub-display 382 of the electronic device 101 (e.g., the sub-display 382 of FIGS. 3 to 5 and 8) in response to the existence of the external electronic device 710 in the charger 610.

In operation 940, the processor 120 in an embodiment may wirelessly supply power to the external electronic device 710 using the charger 610.

In operation 950, the processor 120 in an embodiment may maintain the screen of the sub-display 382 turned on while supplying power to the external electronic device 710. The sub-display 382 may display a screen related to a state of charge. The sub-display 382 may display a screen related to the function of the electronic device 101. The sub-display 382 may display a screen of an application running on the electronic device 101.

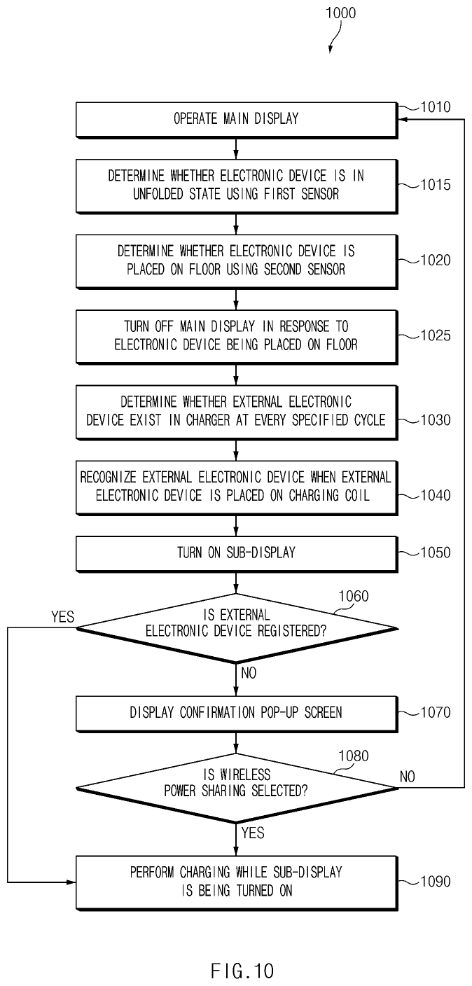

FIG. 10 is a flowchart 1000 showing a method of charging an external electronic device (e.g., the external electronic device 710 of FIGS. 7 and 8) using an electronic device (e.g., the electronic device 101 of FIGS. 1 and 3 to 5).

In operation 1010, the processor (e.g., the processor 120 of FIG. 1) of the electronic device 101 in an embodiment may operate a main display (e.g., the display 210 of FIGS. 2 to 5). The processor 120 may turn on the main display 210 when the electronic device 101 is in an unfolded state. The main display 210 may display a screen related to a function of the electronic device 101. The main display 210 may display a screen of an application running on the electronic device 101.

In operation 1015, the processor 120 in an embodiment may determine whether the electronic device 101 is in the unfolded state by a first sensor included in a sensor module (e.g., the sensor module 176 of FIG. 1). The first sensor may be a hall sensor. The processor 120 may proceed to operation 1020 when the electronic device 101 is in the unfolded state.

In operation 1020, the processor 120 in an embodiment may determine whether a first side (front side) of the electronic device 101 is placed on the floor using a second sensor included in the sensor module 176. The second sensor may be an acceleration sensor, a gyro sensor, a proximity sensor, an illuminance sensor, and/or a geomagnetic sensor. The processor 120 may proceed to operation 1025 when the first side (front side) of the electronic device 101 is placed on the floor.

In operation 1025, the processor 120 in an embodiment may turn off the main display 210 in response to a state in which the electronic device 101 is placed on the floor. When the processor 120 detects that the first side (front side) of the electronic device 101 is placed on the floor, the processor 120 may cause the main display 210 to stop displaying the screen. When the first side (front side) of the electronic device 101 is placed on the floor, the processor 120 may turn off the main display 210 to reduce unnecessary operation or power consumption in the main display 210.

In operation 1030, the processor 120 in an embodiment may determine whether the external electronic device 710 exists at every specified cycle. The processor 120 may determine whether or not a device to be charged is at predetermined time intervals. The processor 120 may proceed to operation 1040 when the external electronic device 710 exists.

In operation 1040, the processor 120 in an embodiment may recognize the external electronic device 710 when the external electronic device is placed on a charging coil (e.g., the charger 610 of FIGS. 6 to 8).

In operation 1050, the processor 120 in an embodiment may turn on a sub-display (e.g., the sub-display 382 of FIGS. 3 to 5 and 8). The processor 120 may turn on the sub-display 382 when an external electronic device is placed on the charger 610.

In operation 1060, the processor 120 in an embodiment may determine whether the external electronic device 710 is registered. The processor 120 may identify an NFC ID of the external electronic device 710 by the communication circuit (e.g., the wireless communication circuit 192 of FIG. 1) of the electronic device 101 in response to the existence of the external electronic device 710. The processor 120 may determine that the external electronic device 710 is registered when the NFC ID of the external electronic device 710 matches at least one registered NFC ID stored in the memory of the electronic device 101 (e.g., the memory 130 of FIG. 1). When the external electronic device 710 is registered (operation 1060—YES), the processor 120 may proceed to operation 1090. The processor 120 may proceed to operation 1070 when the external electronic device 710 is not registered or it is hard to determine whether the external electronic device 710 is registered (operation 1060—NO).

In operation 1070, the processor 120 in an embodiment may display a confirmation pop-up screen. The confirmation pop-up screen may include a user interface for checking whether to supply power to the external electronic device 710. When the external electronic device 710 is not registered or it is hard to determine whether the external electronic device 710 is registered, the processor 120 may display a user interface for checking whether to supply power to the external electronic device 710 on the screen of the sub-display 382.

In operation 1080, the processor 120 in an embodiment may determine whether wireless power sharing is selected. The processor 120 may determine whether the user selects a menu for performing wireless power sharing or a menu for blocking wireless power sharing on the confirmation pop-up screen. When wireless power sharing is selected (operation 1080—YES), the processor 120 may proceed to operation 1090. When blocking of wireless power sharing is selected (operation 1080—NO), the processor 120 may return to operation 1010 and operate the main display 210.

In operation 1090, the processor 120 in an embodiment may perform charging while maintaining the sub-display 382 turned on. When the external electronic device 710 is registered (operation 1060—YES), the processor 120 may automatically charge the external electronic device 710 using the charger 610. When the external electronic device 710 is not registered or it is hard to determine whether the external electronic device 710 is registered (Operation 1060—NO) and wireless power sharing is selected on the confirmation pop-up screen (Operation 1080—YES), the processor 120 may charge the external electronic device 710 using the charger 610.

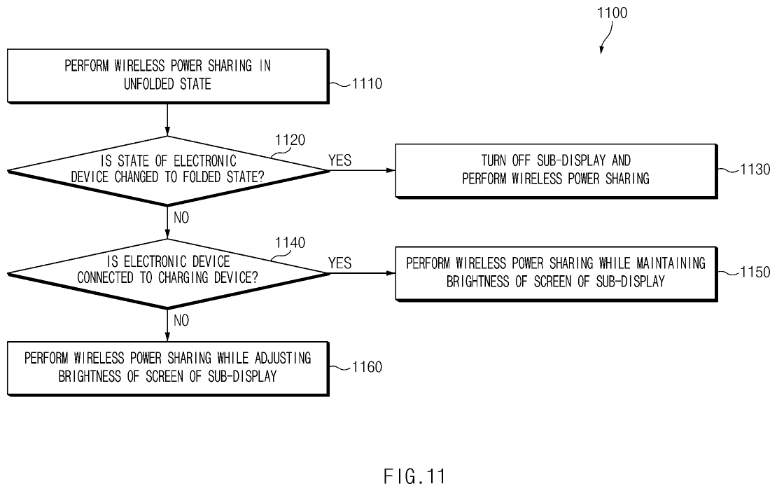

FIG. 11 is a flowchart 1100 showing a method of performing wireless power sharing while controlling a sub-display (e.g., the sub-display 382 of FIGS. 3 to 5 and 8) based on a state of an electronic device (e.g., the electronic device 101 of FIGS. 1, and 3 to 5) and whether the electronic device is connected to a charging device.

In operation 1110, the processor (e.g., the processor 120 of FIG. 1) of the electronic device 101 in an embodiment may perform wireless power sharing in an unfolded state. The processor 120 may wirelessly supply power to the external electronic device 710 (e.g., the external electronic device 710 of FIGS. 7 and 8) using a charger (e.g., the charger 610 of FIGS. 6 to 8) in a state where the first side (front side) faces an external ground in the unfolded state. The processor 120 may maintain the screen of the sub-display 382 turned on while supplying power to the external electronic device 710.

In operation 1120, the processor 120 in an embodiment may identify whether the state of the electronic device 101 is changed to a folded state. The sensor module (e.g., the sensor module 176 of FIG. 1) of the electronic device 101 may include a hall sensor. The processor 120 may identify whether the state of the electronic device 101 is changed into a folded state by a hall sensor. When the state of the electronic device 101 is changed to the folded state (operation 1120—YES), the processor 120 may proceed to operation 1130. The processor 120 may proceed to operation 1140 when the state of the electronic device 101 is maintained unfolded (operation 1120—NO).

In operation 1130, the processor 120 in an embodiment may turn off the sub-display 382 and perform wireless power sharing. When the electronic device 101 is changed into the folded state, the processor 120 may determine that the sub-display 382 is not used while the external electronic device 710 is being charged and turn off the sub-display 382.

In operation 1140, the processor 120 in an embodiment may determine whether the electronic device 101 is connected to a charging device. The processor 120 may determine whether the electronic device 101 is connected to the charging device using a power management module (e.g., the power management module 188 of FIG. 1) and an interface (e.g., the interface 177 of FIG. 1). The charging device may be a wired charging device. However, the charging device is not limited thereto and may be an auxiliary battery or a wireless charging pad. The processor 120 may proceed to operation 1150 when the electronic device 101 is connected to the charging device (operation 1140—YES). The processor 120 may proceed to operation 1160 when the electronic device 101 is not connected to the charging device (operation 1140—NO).

In operation 1150, the processor 120 in an embodiment may perform wireless power sharing while maintaining the brightness of the screen of the sub-display 382. When the electronic device 101 is connected to the charging device, the processor 120 may determine that the electronic device 101 receives additional power from the outside. The processor 120 may maintain the brightness of the screen of the sub-display 382 while performing wireless power sharing based on receiving additional power from the outside.

In operation 1160, the processor 120 in an embodiment may perform wireless power sharing while adjusting the brightness of the screen of the sub-display 382. The processor 120 may perform wireless power sharing while the brightness of the screen of the sub-display 382 has been reduced. When the electronic device 101 is not connected to a charging device, the processor 120 may determine that the electronic device 101 uses a battery (e.g., the battery 189 of FIG. 1) and receives no power from the outside. The processor 120 may adjust the brightness of the screen of the sub-display 382 during wireless power sharing to adjust the use speed of the battery 189 and secure the use time of the electronic device 101.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other feature (e.g., importance or order). It is to be understood that when an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

In various embodiments, each component (e.g., a module or a program) of the above-described components may include a single entity or multiple entities, and some of the multiple entities may be separately disposed in different components. In various embodiments, one or more of the above-described components may be omitted, or one or more other components may be added. In alternative or additional embodiments, a plurality of components (e.g., modules or programs) may be integrated into a single component. In such a case, in various embodiments, the integrated component may still perform one or more functions of each of the plurality of components in the same or similar manner as they are performed by a corresponding one of the plurality of components before the integration. In various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device including a folded state and an unfolded state, comprising:
a housing including:
a first side which is covered in the folded state and visible to outside in the unfolded state; and
a second side which faces a direction opposite to the first side in the unfolded state;
a main display externally visible to the outside through the first side in the unfolded state;
a sub-display disposed in a first area of the second side;
a charger disposed in a second area of the second side;
a sensor module; and
a processor operatively connected to the main display, the sub-display, the charger, and the sensor module,
wherein the processor:
determines whether the electronic device is in the unfolded state using the sensor module;
determines whether the first side is placed on an external ground using the sensor module;
determines whether an external electronic device exists in the charger in response to the electronic device being in the unfolded state and the first side being placed on the external ground;
turns on a screen of the sub-display in response to existence of the external electronic device in the charger;
wirelessly supplies power to the external electronic device using the charger; and
maintains the screen of the sub-display turned on while supplying the power to the external electronic device.

2. The electronic device of claim 1, wherein a first rear cover of the second side of the housing is disposed in the first area,
wherein a second rear cover of the second side of the housing is disposed in the second area, and
wherein the first area and the second area are disposed on opposite sides of a folding axis, which is a boundary line along which the main display is folded.

3. The electronic device of claim 1, wherein the charger includes a charging coil.

4. The electronic device of claim 1, wherein the sensor module includes at least one of an acceleration sensor, a gyro sensor, a proximity sensor, an illuminance sensor, and a geomagnetic sensor, and
wherein the processor determines whether the first side is placed on a floor using at least one of the acceleration sensor, the gyro sensor, the proximity sensor, the illuminance sensor, and the geomagnetic sensor.

5. The electronic device of claim 1, wherein the processor determines whether the external electronic device exists in the charger at every specified cycle.

6. The electronic device of claim 1, further comprising:
a memory which stores at least one registered near field communication identifier; and
a communication circuit,
wherein the processor identifies a near field communication identifier of the external electronic device using the communication circuit in response to existence of the external electronic device in the charger.

7. The electronic device of claim 6, wherein the processor supplies the power to the external electronic device using the charger in response to the near field communication identifier of the external electronic device matching the at least one registered near field communication identifier.

8. The electronic device of claim 6, wherein the processor displays a user interface for checking whether or not to supply the power to the external electronic device on the screen of the sub-display in response to the near field communication identifier of the external electronic device being different from at least one registered near field communication identifier stored in the memory or a time desired for the communication circuit and establishes near field communication with the external electronic device having passed a threshold time.

9. The electronic device of claim 8, wherein the processor supplies the power to the external electronic device using the charger in response to selecting wireless power sharing, and supplies the power to the external electronic device through the user interface.

10. The electronic device of claim 1, wherein the sensor module includes a Hall sensor,
wherein the processor:
determines whether a state of the electronic device is changed to the folded state using the hall sensor while the power is supplied to the external electronic device; and
turns off the sub-display and perform wireless power sharing in response to the state of the electronic device being changed to the folded state.

11. The electronic device of claim 1, further comprising:
a power management module; and
an interface,
wherein the processor determines whether a charging device is connected to the electronic device using at least one of the power management module and the interface while the power is being supplied to the external electronic device, and
wherein the charging device includes a wired charging device.

12. The electronic device of claim 11, wherein the processor performs wireless power sharing while maintaining brightness of the screen of the sub-display in response to the charging device being connected to the electronic device.

13. The electronic device of claim 11, wherein the processor performs wireless power sharing while adjusting brightness of the screen of the sub-display in response to the charging device being not connected to the electronic device.

14. A method of supplying power to an external electronic device using an electronic device, the method comprising:
determining whether the electronic device is in an unfolded state by a sensor module of the electronic device;
determining whether a first side of a housing of the electronic device is placed on an external ground by the sensor module;
determining whether the external electronic device exists in a charger of the electronic device in response to the electronic device being in the unfolded state and the first side being placed on the external ground;
turning on a screen of a sub-display of the electronic device in response to existence of the external electronic device in the charger;
supplying power wirelessly to the external electronic device using the charger; and
maintaining the screen of the sub-display turned on while supplying the power to the external electronic device.

15. The method of claim 14, wherein the determining whether the first side is placed on the external ground includes determining whether the first side is placed on a floor using at least one of an acceleration sensor, a gyro sensor, a proximity sensor, an illuminance sensor, and a geomagnetic sensor included in the sensor module.

16. The method of claim 14, wherein the determining whether the external electronic device exists in the charger includes determining whether the external electronic device exists in the charger at every specified cycle.

17. The method of claim 14, further comprising:
identifying a near field communication identifier of the external electronic device using a communication circuit of the electronic device in response to existence of the external electronic device in the charger.

18. The method of claim 17, wherein the supplying the power wirelessly to the external electronic device using the charger includes supplying the power to the external electronic device using the charger in response to the near field communication identifier of the external electronic device matching at least one registered near field communication identifier stored in a memory of the electronic device.

19. The method of claim 17, further comprising:
displaying a user interface for checking whether or not to supply the power to the external electronic device on the screen of the sub-display in response to the near field communication identifier of the external electronic device being different from at least one registered near field communication identifier or a time required for the communication circuit to establish near field communication with the external electronic device having passed a threshold time.

20. The method of claim 14, further comprising:
determine whether a charging device is connected to the electronic device using at least one of a power management module and an interface while the power is being supplied to the external electronic device; and
performing wireless power sharing while adjusting brightness of the screen of the sub-display in response to the charging device being not connected to the electronic device.
